(19) United States
(12) Patent Application Publication
(10) Pub. No.: US 2025/0357707 A1
(43) Pub. Date: Nov. 20, 2025

(54) ELECTRICAL CONNECTOR WITH ABUTTING POST FOR POSITIONING BUILT-IN CIRCUIT BOARD

(71) Applicant: DONGGUAN LUXSHARE TECHNOLOGIES CO., LTD, Dongguan City (CN)

(72) Inventors: Sihai YI, Dongguan City (CN); Zhaolong ZENG, Dongguan City (CN)

(73) Assignee: DONGGUAN LUXSHARE TECHNOLOGIES CO., LTD, Dongguan City (CN)

(21) Appl. No.: 18/903,715

(22) Filed: Oct. 1, 2024

(30) Foreign Application Priority Data
May 15, 2024 (CN) 202410605993.9

(51) Int. Cl. H01R 13/66; H01R 13/512; H01R 13/633

(52) U.S. Cl. CPC H01R 13/6658; H01R 13/512; H01R 13/6335

(57) ABSTRACT

An electrical connector includes a housing, a first built-in circuit board and a second built-in circuit board. The housing includes a first housing and a second housing. The first housing includes a first abutting post. The first built-in circuit board includes a first base portion and a first tongue portion. The second built-in circuit board includes a second base portion and a second tongue portion. The first built-in circuit board and the second built-in circuit board are stacked. The first abutting protrusion at least partially passes through the first base portion along a second direction to abut against the second base portion.

### CROSS-REFERENCE TO RELATED APPLICATION

This patent application claims priority of a Chinese Patent Application No. 202410605993.9, filed on May 15, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

An electrical connector in the related art includes a first housing, a second housing, a first built-in circuit board, a second built-in circuit board, and an intermediate component. The intermediate component is located between the first housing and the second housing, and is configured to separate and fix the first built-in circuit board and the second built-in circuit board.

However, this design has a relative complex structure and is not conducive to assembly because the intermediate component occupies a space between the first built-in circuit board and the second built-in circuit board.

### SUMMARY

An object of the present disclosure is to provide an electrical connector with improved structures.

In order to achieve the above object, the present disclosure adopts the following technical solution: an electrical connector, including: a housing, the housing including a mating space configured to mate with a mating connector; the housing including a first housing and a second housing; the first housing including a first abutting post; a first built-in circuit board, the first built-in circuit board including a first base portion and a first tongue portion protruding beyond the first base portion along a first direction; and a second built-in circuit board, the second built-in circuit board including a second base portion and a second tongue portion protruding beyond the second base portion along the first direction; wherein the first built-in circuit board and the second built-in circuit board are disposed in a stacked manner along a second direction; the second direction is perpendicular to the first direction; the first built-in circuit board and the second built-in circuit board are at least partially located between the first housing and the second housing; the first tongue portion and the second tongue portion protrude into the mating space along the first direction so as to be configured to be inserted into the mating connector; the first abutting post at least partially passes through the first base portion along the second direction to abut against the second base portion.

In order to achieve the above object, the present disclosure adopts the following technical solution: an electrical connector, including: a housing, the housing including a mating space configured to mate with a mating connector; the housing including a first housing and a second housing; the first housing including a first abutting post; a first built-in circuit board, the first built-in circuit board including a first base portion and a first tongue portion extending from the first base portion along a first direction; the first base portion including a first surface, a second surface opposite to the first surface, a plurality of first mounting conductive pads provided on the first surface and a plurality of second mounting conductive pads provided on the second surface; a second built-in circuit board, the second built-in circuit board including a second base portion and a second tongue portion extending from the second base portion along the first direction; the second base portion including a third surface, a fourth surface opposite to the third surface, a plurality of third mounting conductive pads provided on the third surface and a plurality of fourth mounting conductive pads provided on the fourth surface; a plurality of first cables electrically connected to the plurality of first mounting conductive pads; a plurality of second cables electrically connected to the plurality of second mounting conductive pads; a plurality of third cables electrically connected to the plurality of third mounting conductive pads; and a plurality of fourth cables electrically connected to the plurality of fourth mounting conductive pads; wherein the first built-in circuit board and the second built-in circuit board are disposed in a stacked manner along a second direction perpendicular to the first direction; a receiving space configured to accommodate the plurality of second cables and the plurality of third cables in the second direction is formed between the first base portion and the second base portion along the second direction; the first tongue portion and the second tongue portion protrude into the mating space along the first direction to mate with the mating connector; the first abutting post at least partially passes through the first base portion along the second direction to abut against the second base portion.

Compared with the prior art, the first housing of the electrical connector of the present disclosure is provided with the first abutting post. The first abutting post at least partially passes through the first base portion along the second direction to abut against the second base portion. With this arrangement, the intermediate component in the related art can be omitted, thereby simplifying the structures of the electrical connector and improving the convenience of assembling the electrical connector.

### BRIEF DESCRIPTION OF DRAWINGS

FIG. 1 is a schematic perspective view of an electrical connector in accordance with an embodiment of the present disclosure;

FIG. 2 is a perspective view of FIG. 1 from another angle;

FIG. 3 is a partially exploded perspective view of FIG. 1;

FIG. 4 is a partially exploded perspective view of FIG. 3 from another angle;

FIG. 5 is a partial enlarged view of a circled part B in FIG. 3;

FIG. 6 is a partial enlarged view of a circled portion C in FIG. 3;

FIG. 7 is a partial enlarged view of a circled portion D in FIG. 4;

FIG. 8 is a schematic cross-sectional view taken along line E-E in FIG. 1; and

FIG. 9 is a schematic cross-sectional view taken along line F-F in FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

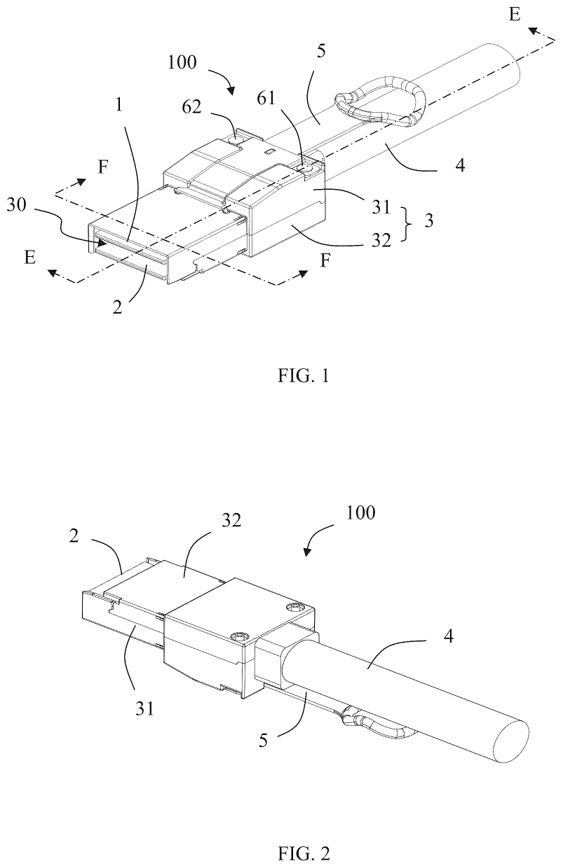

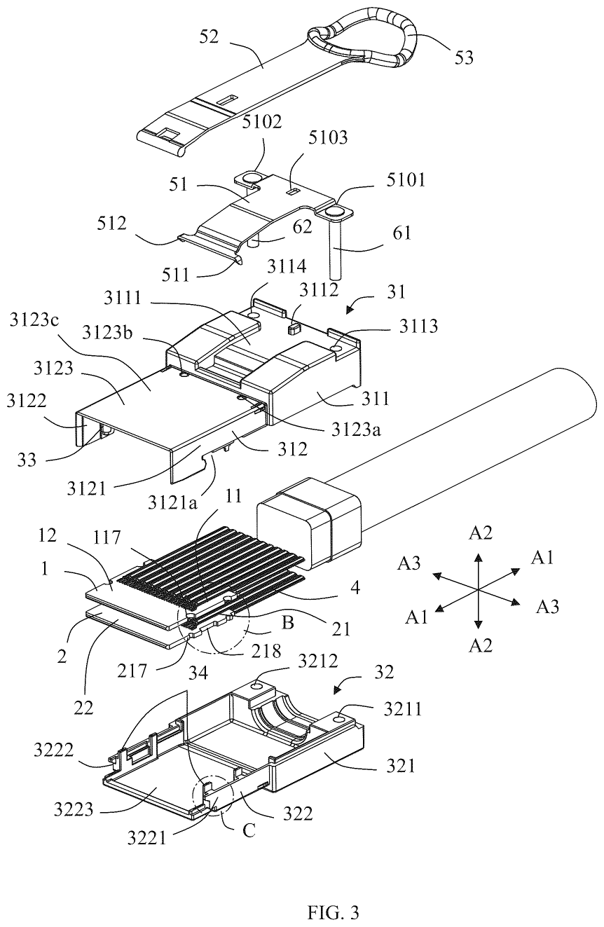

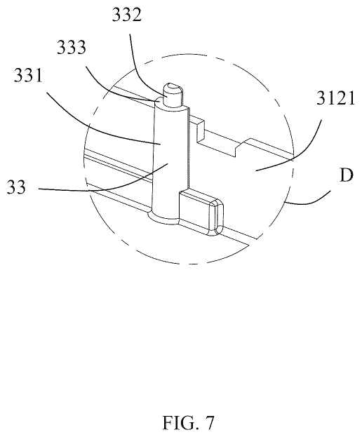

Referring to FIG. 1 to FIG. 9, the present disclosure discloses an electrical connector 100, which includes a housing 3, a first built-in circuit board 1 mounted in the housing 3, a second built-in circuit board 2 mounted in the housing 3, a plurality of cables 4, and a pull strap assembly 5 fixed to the housing 3. In an illustrated embodiment of the present disclosure, the electrical connector 100 is a plug connector, which is configured to be inserted into a mating connector (not shown) to achieve the electrical connection with the mating connector. The pull strap assembly 5 is configured to pull out the electrical connector 100 from the mating connector when it is necessary to separate the electrical connector 100 and the mating connector from each other.

The housing 3 includes a mating space 30 configured to mate with the mating connector. In the illustrated embodiment of the present disclosure, the housing 3 includes a first housing 31 and a second housing 32. The first housing 31 and the second housing 32 are assembled together. The mating space 30 is formed by the first housing 31 and the second housing 32.

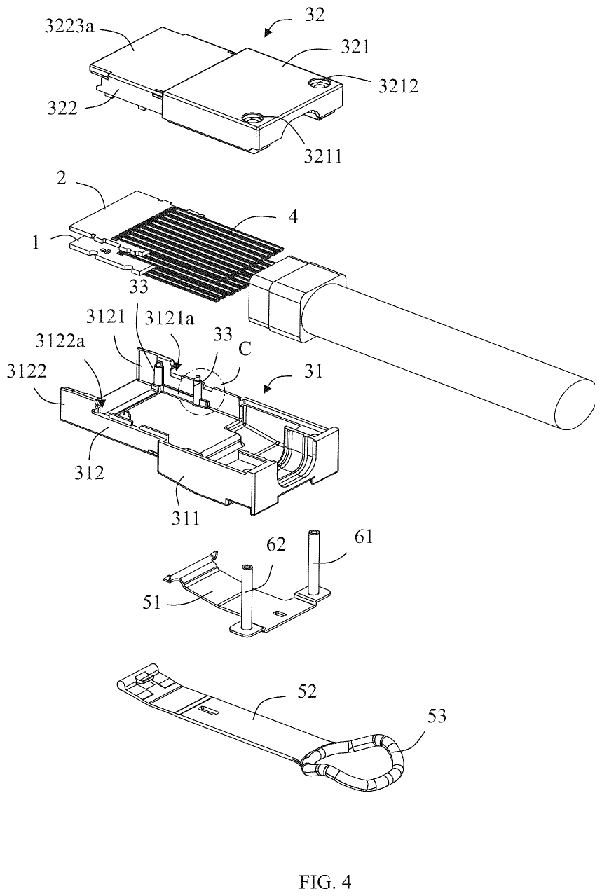

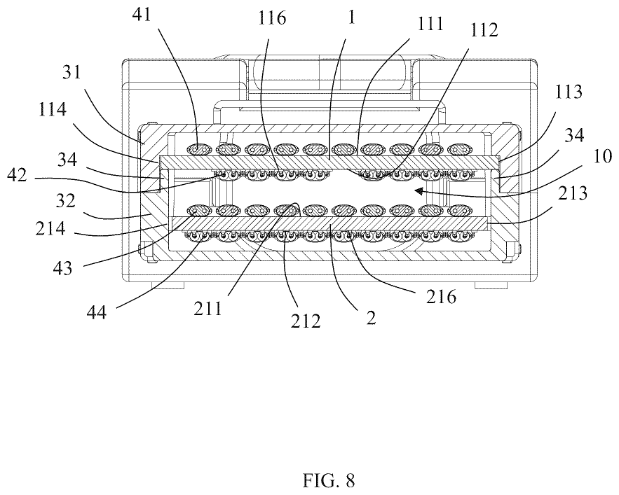

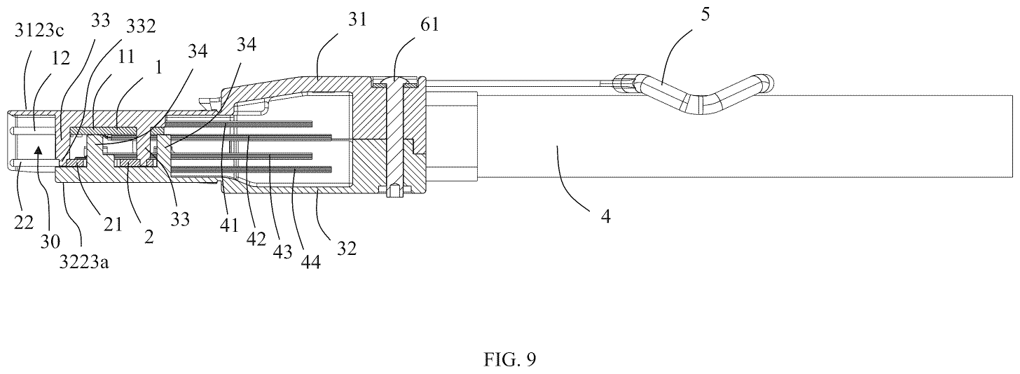

Referring to FIG. 3, FIG. 4, FIG. 8 and FIG. 9, in the illustrated embodiment of the present disclosure, the first housing 31 includes a first body portion 311 and a first extension portion 312 extending from the first body portion 311. The first body portion 311 includes a substantially T-shaped mounting groove 3111, at least one protrusion block 3112 located in the mounting groove 3111, and a first mounting channel 3113 and a second mounting channel 3114 which are located in the mounting groove 3111 and communicating with the mounting groove 3111. The protrusion block 3112 is located between the first mounting channel 3113 and the second mounting channel 3114.

The first extension portion 312 includes a first side wall 3121, a second side wall 3122 opposite to the first side wall 3121, and a first outer wall 3123 (for example, a top wall) connecting the first side wall 3121 and the second side wall 3122. The first outer wall 3123 is provided with a top surface 3123c.

In the illustrated embodiment of the present disclosure, the first side wall 3121 and the second side wall 3122 are arranged symmetrically. Both an inner side of the first side wall 3121 and an inner side of the second side wall 3122 include a plurality of first abutting posts 33 which are spaced apart along a first direction Al-A1 (for example, a front-rear direction). In the illustrated embodiment of the present disclosure, the plurality of first abutting posts 33 are integrally formed with the first side wall 3121 and the second side wall 3122 so as to improve structural strength.

In the illustrated embodiment of the present disclosure, each first abutting post 33 includes a first main body portion 331, a first end portion 332 connected to the first main body portion 331, and a first abutting surface 333 located at an interface of the first main body portion 331 and the first end portion 332. In the illustrated embodiment of the present disclosure, both the first main body portion 331 and the first end portion 332 have arc-shaped side surfaces 334.

Besides, the first side wall 3121 defines a first recess 3121a. The second side wall 3122 define a second recess 3122a. The first recess 3121a and the second recess 3122a are configured to mate with the second housing 32.

In the illustrated embodiment of the present disclosure, the first outer wall 3123 defines a first holding recess 3123a and a second holding recess 3123b. The first holding recess 3123a and the second holding recess 3123b are configured to mate with the pull strap assembly 5.

In the illustrated embodiment of the present disclosure, the pull strap assembly 5 includes a fixing plate 51 fixed to the first housing 31, a pull strap 52 connected to the fixing plate 51, and a pull ring 53 connected to the pull strap 52. In one embodiment of the present disclosure, the fixing plate 51 includes a T-shaped mounting portion 510 received in the mounting groove 3111, a first hook portion 511 extending forwardly from the mounting portion 510, and a second hook portion 512 extending forwardly from the mounting portion 510. The first hook portion 511 and the second hook portion 512 are located on two sides of the fixing plate 51. The first hook portion 511 is clamped in the first holding recess 3123a. The second hook portion 512 is clamped in the second holding recess 3123b. In an embodiment of the present disclosure, the fixing plate 51 and the first housing 31 are both made of metal material. The first hook portion 511 and the second hook portion 512 may also be fixed to the first housing 31 by soldering or welding, so as to improve the binding force therebetween.

In the illustrated embodiment of the present disclosure, the mounting portion 510 defines a first mounting hole 5101 corresponding to the first mounting channel 3113, a second mounting hole 5102 corresponding to the second mounting channel 3114, and a mating groove 5103 mating with the protrusion block 3112. A front end of the pull strap 52 is fastened to the protrusion block 3112.

The second housing 32 includes a second body portion 321 and a second extension portion 322 extending from the second main body portion 321. The second main body portion 321 mates with the first body portion 311. The second main body portion 321 defines a third mounting channel 3211 corresponding to the first mounting channel 3113 and a fourth mounting channel 3212 corresponding to the second mounting channel 3114.

In the illustrated embodiment of the present disclosure, the electrical connector 100 is further provided with a first fastener 61 and a second fastener 62. In an embodiment of the present disclosure, the first fastener 61 and the second fastener 62 are both fastening bolts.

When the pull strap assembly 5 is mounted to the first housing 31, the first fastener 61 is inserted into the first mounting hole 5101, the first mounting channel 3113 and the third mounting channel 3211 in sequence, and is then fixed to the second housing 32. Similarly, the second fastener 62 is inserted into the second mounting hole 5102, the second mounting channel 3114 and the fourth mounting channel 3212 in sequence, and is then fixed to the second housing 32. Of course, it is understandable to those skilled in the art that the assembly method of the pull strap assembly 5 and the first housing 31 can be flexibly adjusted as needed, which is not limited by the present disclosure.

The second extension portion 322 includes a third side wall 3221, a fourth side wall 3222 opposite to the third side wall 3221, and a second outer wall 3223 (for example, a bottom wall) connecting the third side wall 3221 and the fourth side wall 3222.

In the illustrated embodiment of the present disclosure, the third side wall 3221 and the fourth side wall 3222 are arranged symmetrically. Both an inner sides of the third side wall 3221 and an inner side of the fourth side wall 3222 include a plurality of second abutting posts 34 which are spaced apart along the first direction A1-A1. In the illustrated embodiment of the present disclosure, the plurality of second abutting posts 34 are integrally formed with the third side wall 3221 and the fourth side wall 3222 so as to improve structural strength.

Referring to FIG. 6, in the illustrated embodiment of the present disclosure, each second abutting post 34 includes an abutting protrusion 341 located at an end (for example, a top end) of the second abutting post 34. The abutting protrusion 341 is provided with a second abutting surface 3411. It is understandable to those skilled in the art that in the illustrated embodiment of the present disclosure, the size of the abutting post 341 is smaller, so that the second abutting surface 3411 is not subject to its own flatness requirements, reliable contact with the first built-in circuit board 1 can be achieved.

In the illustrated embodiment of the present disclosure, the third side wall 3221 and the fourth side wall 3222 are at least partially received in the first recess 3121a and the second recess 3122a, respectively. The second outer wall 3223 is provided with a bottom surface 3223a.

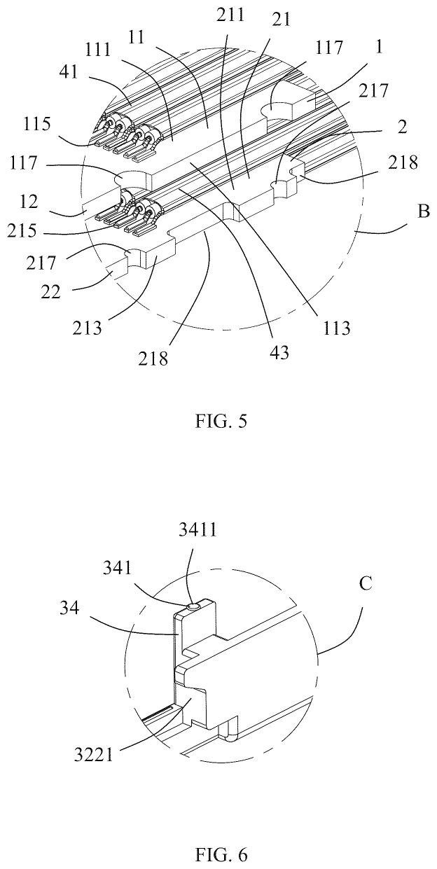

Referring to FIG. 5, FIG. 8 and FIG. 9, in the illustrated embodiment of the present disclosure, the first built-in circuit board 1 includes a first base portion 11 and a first tongue portion 12 protruding beyond the first base portion 11 along the first direction A1-A1. The first base portion 11 includes a first surface 111 (for example, an upper surface), a second surface 112 (for example, a lower surface) opposite to the first surface 111, a first side edge 113 located on one side (for example, a left side) of the first base portion 11, a second side edge 114 located on another side (for example, a right side) of the first base portion 11, a plurality of first mounting conductive pads 115 provided on the first surface 111, and a plurality of second mounting conductive pads 116 provided on the second surface 112.

In the illustrated embodiment of the present disclosure, both the first side edge 113 and the second side edge 114 define a plurality of first slots 117 which are spaced apart along the first direction A1-A1. The first slot 117 extends through the first base portion 11 along a second direction A2-A2 (for example, a top-bottom direction). In the illustrated embodiment of the present disclosure, the first slot 117 is C-shaped. Of course, it is understandable to those skilled in the art that the number and shape of the first slots 117 can be flexibly designed according to needs; for example, the first slot 117 can also be U-shaped, rectangular, circular, etc.

The first tongue portion 12 protrudes into the mating space 30. The first tongue portion 12 includes a plurality of first contact conductive pads (not shown) exposed in the mating space 30 to make electrical contact with the mating connector.

In the illustrated embodiment of the present disclosure, the second built-in circuit board 2 includes a second base portion 21 and a second tongue portion 22 protruding beyond the second base portion 21 along the first direction A1-A1. The second base portion 21 includes a third surface 211 (for example, an upper surface), a fourth surface 212 (for example, a lower surface) opposite to the third surface 211, a third side edge 213 located on one side (for example, a left side) of the second base portion 21, a fourth side edge 214 located on another side (for example, a right side) of the second base portion 21, a plurality of third mounting conductive pads 215 provided on the third surface 211, and a plurality of fourth mounting conductive pads 216 provided on the fourth surface 212.

In the illustrated embodiment of the present disclosure, both the third side edge 213 and the fourth side edge 214 define a plurality of second slots 217 which are spaced apart along the first direction A1-A1. The second slot 217 extends through the second base portion 21 along the second direction A2-A2. In the illustrated embodiment of the present disclosure, the second slot 217 is C-shaped. Of course, it is understandable to those skilled in the art that the number and shape of the second slots 217 can be flexibly designed according to needs; for example, the first slot 117 can also be U-shaped, rectangular, circular, etc. In the illustrated embodiment of the present disclosure, the first slot 117 is larger than the second slot 217 in size so that the first abutting post 33 is able to pass through the first slot 117 smoothly. In the illustrated embodiment of the present disclosure, a size of the first slot 117 along the first direction A1-A1 is larger than a size of the second slot 217 along the first direction A1-A1, so that the first abutting post 33 is able to pass through the first slot 117 smoothly.

In the illustrated embodiment of the present disclosure, the second base portion 21 is further provided with a relief groove 218 extending through the second base portion 21 along the second direction A2-A2. In the illustrated embodiment of the present disclosure, both the third side edge 213 and the fourth side edge 214 define a plurality of relief grooves 218 which are spaced apart along the first direction A1-A1.

The second tongue portion 22 protrudes into the mating space 30. The second tongue portion 22 includes a plurality of second contact conductive pads (not shown) exposed in the mating space 30 to make electrical contact with the mating connector.

The plurality of cables 4 include a plurality of first cables 41 electrically connected to the plurality of first mounting conductive pads 115, a plurality of second cables 42 electrically connected to the plurality of second mounting conductive pads 116, a plurality of third cables 43 electrically connected to the plurality of third mounting conductive pads 215, and a plurality of fourth cables 44 electrically connected to the plurality of fourth mounting conductive pads 216. The plurality of second cables 42 and the plurality of third cables 43 are located in a receiving space 10 between the first base portion 11 and the second base portion 21 along the second direction A2-A2, which facilitates the arrangement of the plurality of second cables 42 and the plurality of third cables 43.

The first built-in circuit board 1 and the second built-in circuit board 2 are disposed in a stacked manner along the second direction A2-A2, and are at least partially located between the first housing 31 and the second housing 32. The first tongue portion 12 and the second tongue portion 22 protrude into the mating space 30 along the first direction A1-A1 to be configured to be inserted into the mating connector.

During assembly, the first abutting post 33 at least partially passes through the first base portion 11 along the second direction A2-A2 to abut against the second base portion 21. The second abutting post 34 at least partially passes through the second base portion 21 along the second direction A2-A2 to abut against the first base portion 11. With this arrangement, the first built-in circuit board 1 and the second built-in circuit board 2 can be fixed in the second direction A2-A2.

Referring to FIG. 5 to FIG. 9, specifically, in the illustrated embodiment of the present disclosure, the first main body portion 331 of the first abutting post 33 at least partially passes through the first slot 117. The first abutting surface 333 of the first abutting post 33 abuts against the second base portion 21 along the second direction A2-A2. The first end portion 332 of the first abutting post 33 is received in the second slot 217. Specifically, after the first abutting post 33 at least partially passes through the first base portion 11 along the second direction A2-A2, the first abutting surface 333 of the first abutting post 33 abuts against the third surface 211 of the second base portion 21. In the illustrated embodiment of the present disclosure, an outer contour of the first main body portion 331 matches the first slot 117 so that the first main body portion 331 is able to limit the position of the first built-in circuit board 1 along the first direction A1-A1 and/or along a third direction A3-A3 (for example, a left-right direction). In the illustrated embodiment of the present disclosure, an outer contour of the first end portion 332 matches the second slot 217 so that the first end portion 332 is able to limit the position of the second built-in circuit board 2 along the first direction A1-A1 and/or along the third direction A3-A3. The third direction A3-A3 is perpendicular to the first direction A1-A1 and the second direction A2-A2.

The second abutting post 34 at least partially passes through the relief groove 218 along the second direction A2-A2 to abut against the first base portion 11. Specifically, after the second abutting post 34 at least partially passes through the second base portion 21 along the second direction A2-A2, the second abutting surface 3411 of the abutting protrusion 341 of the second abutting post 34 abuts against the second surface 112 of the first base portion 11.

After installation, the top surface 3123c, the first built-in circuit board 1, the second built-in circuit board 2 and the bottom surface 3223a are disposed in sequence from top to bottom along the second direction A2-A2.

Compared with the prior art, the first housing 31 and the second housing 32 of the electrical connector 100 of the present disclosure are respectively provided with the first abutting post 33 and a second abutting post 34. The first abutting post 33 at least partially passes through the first base portion 11 along the second direction A2-A2 to abut against the second base portion 21. The second abutting post 34 at least partially passes through the second base portion 21 along the second direction A2-A2 to abut against the first base portion 11. With this arrangement, an intermediate component in the related art can be omitted, thereby simplifying the structures of the electrical connector 100 and improving the convenience of assembling the electrical connector 100. Besides, the receiving space 10 located between the first base portion 11 and the second base portion 21 is not only beneficial for cable arrangement, weight reduction, adding electronic components on the built-in circuit board, etc., but also is beneficial for heat dissipation.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a housing, the housing comprising a mating space configured to mate with a mating connector; the housing comprising a first housing and a second housing; the first housing comprising a first abutting post;
a first built-in circuit board, the first built-in circuit board comprising a first base portion and a first tongue portion protruding beyond the first base portion along a first direction; and
a second built-in circuit board, the second built-in circuit board comprising a second base portion and a second tongue portion protruding beyond the second base portion along the first direction;
wherein the first built-in circuit board and the second built-in circuit board are disposed in a stacked manner along a second direction; the second direction is perpendicular to the first direction;
the first built-in circuit board and the second built-in circuit board are at least partially located between the first housing and the second housing; the first tongue portion and the second tongue portion protrude into the mating space along the first direction so as to be configured to be inserted into the mating connector;
the first abutting post at least partially passes through the first base portion along the second direction to abut against the second base portion.

2. The electrical connector according to claim 1, wherein the first abutting post comprises a first main body portion, a first end portion connected to the first main body portion, and a first abutting surface located at an interface of the first main body portion and the first end portion;
the first base portion defines a first slot extending through the first base portion along the second direction;
the second base portion defines a second slot extending through the second base portion along the second direction;
the first main body portion at least partially passes through the first slot; the first abutting surface abuts against the second base portion along the second direction; the first end portion is received in the second slot.

3. The electrical connector according to claim 2, wherein the first end portion is constricted relative to the first main body portion;
the first slot is larger than the second slot in size, so that the first end portion is capable of passing through the first slot to be received in the second slot.

4. The electrical connector according to claim 2, wherein an outer contour of the first main body portion matches the first slot, so that the first main body portion is able to limit a position of the first built-in circuit board at least along the first direction.

5. The electrical connector according to claim 2, wherein an outer contour of the first end portion matches the second slot, so that the first end portion is able to limit a position of the second built-in circuit board at least along the first direction.

6. The electrical connector according to claim 2, wherein the first housing comprises a first side wall and a second side wall opposite to the first side wall; both an inside of the first side wall and an inside of the second side wall comprises at least one first abutting post;
the first built-in circuit board comprises a first side edge and a second side edge opposite to the first side edge; both the first side edge and the second side edge define at least one first slot;
the second built-in circuit board comprises a third side edge and a fourth side edge opposite to the third side edge; both the third side edge and the fourth side edge define at least one second slot.

7. The electrical connector according to claim 6, wherein both the first side wall and the second side wall comprise a plurality of first abutting posts which are spaced apart along the first direction;
both the first side edge and the second side edge define a plurality of first slots which are spaced apart along the first direction;
both the third side edge and the fourth side edge define a plurality of second slots which are spaced apart along the first direction.

8. The electrical connector according to claim 2, wherein the second housing comprises a second abutting post; the second abutting post at least partially passes through the second base portion along the second direction to abut against the first base portion.

9. The electrical connector according to claim 8, wherein the second base portion defines a relief groove extending through the second base portion along the second direction; the second abutting post at least partially passes through the relief groove along the second direction to abut against the first base portion.

10. The electrical connector according to claim 9, wherein the first base portion comprises a first surface and a second surface opposite to the first surface;
the second base portion comprises a third surface and a fourth surface opposite to the third surface;
the second surface of the first base portion and the third surface of the second base portion are disposed facing each other along the second direction;
after the first abutting post at least partially passes through the first base portion along the second direction, the first contact surface abuts against the third surface of the second base portion;
after the second abutting post at least partially passes through the second base portion along the second direction, the second abutting post abuts against the second surface of the first base portion.

11. The electrical connector according to claim 10, wherein the second abutting post comprises an abutting protrusion located at an end of the second abutting post; the abutting protrusion abuts against the second surface of the first base portion.

12. The electrical connector according to claim 9, wherein the second housing comprises a third side wall and a fourth side wall opposite to the third side wall; both an inner side of the third side wall and an inner side of the fourth side wall comprise at least one second abutting post;
the second built-in circuit board comprises a third side edge and a fourth side edge opposite to the third side edge; both the third side edge and the fourth side edge define at least one relief groove.

13. The electrical connector according to claim 12, wherein both the third side wall and the fourth side wall comprise a plurality of second abutting posts which are spaced apart along the first direction;
both the third side edge and the fourth side edge define a plurality of relief grooves which are spaced apart along the first direction.

14. The electrical connector according to claim 10, wherein the first base portion comprises a plurality of first mounting conductive pads provided on the first surface and a plurality of second mounting conductive pads provided on the second surface;
the second base portion comprises a plurality of third mounting conductive pads provided on the third surface and a plurality of fourth mounting conductive pads provided on the fourth surface;
the electrical connector further comprises a plurality of first cables electrically connected to the plurality of first mounting conductive pads, a plurality of second cables electrically connected to the plurality of second mounting conductive pads, a plurality of third cables electrically connected to the plurality of third mounting conductive pads, and a plurality of fourth cables electrically connected to the plurality of fourth mounting conductive pads; the plurality of second cables and the plurality of third cables are located in a receiving space between the first base portion and the second base portion along the second direction.

15. The electrical connector according to claim 1, further comprising a pull strap assembly fixed to the housing and configured to pull out the electrical connector from the mating connector.

16. The electrical connector according to claim 15, wherein the pull strap assembly comprises a fixing plate fixed to the first housing, a pull strap connected to the fixing plate, and a pull ring connected to the pull strap.

17. An electrical connector, comprising:
a housing, the housing comprising a mating space configured to mate with a mating connector; the housing comprising a first housing and a second housing; the first housing comprising a first abutting post;
a first built-in circuit board, the first built-in circuit board comprising a first base portion and a first tongue portion extending from the first base portion along a first direction; the first base portion comprising a first surface, a second surface opposite to the first surface, a plurality of first mounting conductive pads provided on the first surface and a plurality of second mounting conductive pads provided on the second surface;
a second built-in circuit board, the second built-in circuit board comprising a second base portion and a second tongue portion extending from the second base portion along the first direction; the second base portion comprising a third surface, a fourth surface opposite to the third surface, a plurality of third mounting conductive pads provided on the third surface and a plurality of fourth mounting conductive pads provided on the fourth surface;
a plurality of first cables electrically connected to the plurality of first mounting conductive pads;
a plurality of second cables electrically connected to the plurality of second mounting conductive pads;
a plurality of third cables electrically connected to the plurality of third mounting conductive pads; and
a plurality of fourth cables electrically connected to the plurality of fourth mounting conductive pads;
wherein the first built-in circuit board and the second built-in circuit board are disposed in a stacked manner along a second direction perpendicular to the first direction; a receiving space configured to accommodate the plurality of second cables and the plurality of third cables in the second direction is formed between the first base portion and the second base portion along the second direction;
the first tongue portion and the second tongue portion protrude into the mating space along the first direction to mate with the mating connector;
the first abutting post at least partially passes through the first base portion along the second direction to abut against the second base portion.

18. The electrical connector according to claim 17, wherein the first abutting post comprises a first main body portion, a first end portion connected to the first main body portion, and a first abutting surface located at an interface of the first main body portion and the first end portion;
the first base portion defines a first slot extending through the first base portion along the second direction;
the second base portion defines a second slot extending through the second base portion along the second direction;
the first main body portion at least partially passes through the first slot; the first abutting surface abuts against the second base portion along the second direction; the first end portion is received in the second slot.

19. The electrical connector according to claim 18, wherein the first end portion is constricted relative to the first main body portion;
the first slot is larger than the second slot in size, so that the first end portion is capable of passing through the first slot to be received in the second slot.

20. The electrical connector according to claim 18, wherein an outer contour of the first main body portion matches the first slot, so that the first main body portion is able to limit a position of the first built-in circuit board at least along the first direction.
